(19) United States
(12) Patent Application Publication
(10) Pub. No.: US 2026/0103963 A1
(43) Pub. Date: Apr. 16, 2026

(54) In-Line Fluid System with In-Line Fluid End

(71) Applicant: Upwing Energy, Inc., Cerritos, CA (US)

(72) Inventors: Patrick McMullen, Cerritos, CA (US); Kuo-Chiang Chen, Kennedale, TX (US); Christopher Matthew Sellers, Fullerton, CA (US)

(21) Appl. No.: 19/333,275

(22) Filed: Sep. 18, 2025

Related U.S. Application Data
(60) Provisional application No. 63/707,019, filed on Oct. 14, 2024.

(51) Int. Cl. E21B 43/12; F04D 13/02; F16L 37/00; F17D 3/01

(52) U.S. Cl. CPC E21B 43/121; F04D 13/024; F16L 37/002; F16L 37/004; F17D 3/01

(57) ABSTRACT

A fluid production system for a well including a fluid system configured to reside within a conduit residing outside the well. The fluid system includes a fluid end inlet, a fluid end outlet, and an impeller arranged between the fluid end inlet and the fluid end outlet and supported to rotate on a first rotational axis. A first seal is carried by the fluid production system downstream from the fluid end inlet and is configured to seal a space between the fluid end and an inner wall of the conduit. A motor including a rotor is supported to rotate on a second rotational axis, residing on an opposite side of the first seal from the fluid end, and is configured to reside external to the conduit. A magnetic coupling is configured to couple the rotor to the impeller to drive the fluid end via the motor. A second seal is carried by the fluid production system upstream from the fluid end inlet and configured to seal to the inner wall of the conduit proximate the magnetic coupling.

This application claims the benefit under 35 U.S.C. § 119(e) of the prior-filed U.S. Provisional Application No. 63/707,019, filed Oct. 14, 2024, entitled “In Line Sealed Electric Motor for Pipelines,” the contents of such application incorporated by reference herein.

### TECHNICAL FIELD

This disclosure relates to electric powered fluid systems, such as pumps, compressors and blowers.

### BACKGROUND

Pumps, compressors, and blowers can be used within a well to increase fluid flow, thereby extending the life of the well. For example, downhole fluid systems can be used within wells to boost pressure and flow from the wells. Surface fluid systems can be used in transmission pipelines to boost pressure for transmission. Surface fluid systems are often large, and must be accommodated when designing the surface piping layout. Further, equipment failure, whether of downhole (within a well) systems or surface systems, can sometimes require significant downtime, which can be costly. Repair can require shutting in a well or shutting down a pipeline in order to perform the repair, resulting in lost production from the well. Lost production translates to lost revenue and is therefore typically avoided when possible.

### SUMMARY

In general, this document describes electric powered fluid systems.

Certain aspects encompass a fluid system for a well. The fluid system includes a motor in a hermetically sealed housing having a rotor supported to rotate on a rotational axis. The hermetically sealed housing is configured to reside submerged in fluid within a pipe that is residing outside of the well. The hermetically sealed housing includes a power cable extending from the motor through a sidewall of the pipe. The fluid system includes a fluid end coupled to the hermetically sealed housing. The fluid end has a fluid end inlet and an impeller supported to rotate on the rotational axis. The fluid end is configured to drive the fluid and to reside within the pipe. The fluid system includes a seal carried by the fluid system downstream from the fluid end inlet and is configured to seal a space between the fluid end and an inner wall of the pipe. The fluid system includes a magnetic coupling configured to couple the rotor and the motor to drive the fluid end via the motor.

Certain aspects encompass a fluid production system. The fluid production system includes a plurality of pipes of a pipeline, where the pipeline fluidically connects a wellhead to one or more destinations. The fluid production system includes a fluid system having a motor in a hermetically sealed housing with a rotor supported to rotate on a rotational axis. The hermetically sealed housing resides within a pipe of the plurality of pipes and the motor has a power cable extending through a sidewall of the pipe. The fluid system has a fluid end coupled to the hermetically sealed housing and a fluid end inlet and an impeller supported to rotate on the rotational axis. The fluid end resides within the pipe. A seal is carried by the fluid system downstream from the fluid end inlet and seals a space between the fluid end and an inner wall of the pipe. The fluid system has a magnetic coupling that couples the rotor to the impeller to drive the fluid end via the motor.

Certain aspects encompass a method of driving fluid flow from a well. According to the method, a fluid system is arranged within a pipe residing outside of the well and connected in a pipeline. The fluid system includes a motor in a hermetically sealed housing having a rotor supported to rotate on a rotational axis. The hermetically sealed housing is configured to reside submerged in fluid within a pipe that is residing outside of the well. The hermetically sealed housing includes a power cable extending from the motor through a sidewall of the pipe. The fluid system includes a fluid end coupled to the hermetically sealed housing. The fluid end has a fluid end inlet and an impeller supported to rotate on the rotational axis. The fluid end is configured to drive the fluid and to reside within the pipe. The fluid system includes a seal carried by the fluid system downstream from the fluid end inlet and configured to seal a space between the fluid end and an inner wall of the pipe. The fluid system includes a magnetic coupling configured to couple the rotor and the motor to drive the fluid end via the motor. The method encompasses fluidically coupling the pipe in a pipeline arranged outside of the well, and driving, by the fluid end, fluid flow in the pipe.

The aspects above encompass some, none or all of the following features. In certain instances, the magnetic coupling includes a first coupling part that has a first magnet residing outside the hermetically sealed housing and a second coupling part with a second magnet residing inside the hermetically sealed housing. The magnetic coupling can include a non-magnetic fluid barrier arranged at least partly between the first coupling part and the second coupling part. The first magnet and the second magnet produce a magnetic field that extends between the first magnet and the second magnet across the non-magnetic fluid barrier. In certain instances, the rotor is directly coupled to the first coupling part and the impeller is directly coupled to the second coupling part. In certain instances, the hermetically sealed housing is at least partly filled with an incompressible fluid or encapsulant. In certain instances a conduit extends through the pipe, between the hermetically sealed housing and an ambient environment surrounding the pipe. The conduit is hermetically sealed from an interior of the pipe and the power cable extends through the conduit. In certain instances, the pipe is a removable subsection of a pipeline. In certain instances, a static seal is arranged in sealing contact between the power cable and a port in the pipe. In certain instances, none of the motor, the fluid end, the seal, or the magnetic coupling comprise a rotating seal. In certain instances, the fluid end is a multiphase fluid end configured to drive axial flow of multiphase fluid through the pipe along the rotational axis. In certain instances, the motor is configured to transfer heat generated during operation of the motor to fluid flow induced by the impeller through the pipe along the rotational axis. In certain instances the fluid system includes a first magnetic radial bearing configured to support the impeller to the hermetically sealed housing and a second radial magnetic bearing configured to support the rotor to a stator of the motor. In certain instances, the fluid system is configured to rotate the fluid end at 10,000 revolutions per minute. In certain instances, a second pipe is removed from the pipeline and the second pipe is replaced with the first mentioned pipe. In certain instances, the pipeline is arranged in a wellhead, or the pipeline is arranged between the wellhead and a gathering station and/or the destination includes a gathering station. In certain instances, a bypass pipe and a first valve is provided where the valve is configured to direct fluid flow to a selectable one of the pipe and the bypass pipe.

Certain aspects encompass a fluid production system for a well. The fluid production system includes a fluid system configured to reside within a conduit residing outside the well. The fluid system includes a fluid end inlet, a fluid end outlet, and an impeller arranged between the fluid end inlet and the fluid end outlet and supported to rotate on a first rotational axis. A first seal is carried by the fluid production system downstream from the fluid end inlet and is configured to seal a space between the fluid end and an inner wall of the conduit. A motor including a rotor is supported to rotate on a second rotational axis, residing on an opposite side of the first seal from the fluid end, and is configured to reside external to the conduit. A magnetic coupling is configured to couple the rotor to the impeller to drive the fluid end via the motor. A second seal is carried by the fluid production system upstream from the fluid end inlet and configured to seal to the inner wall of the conduit proximate the magnetic coupling.

Certain aspects encompass a fluid production system including a plurality of pipes of a pipeline. The pipeline is fluidically connecting a wellhead to one or more destinations. The fluid production system includes a fluid system having a fluid end residing within a pipe of the plurality pipes and configured to connect inline in the pipeline. The fluid system includes a fluid end inlet, a fluid end outlet, and an impeller arranged between the fluid end inlet and the fluid end outlet and supported to rotate on a first rotational axis. A first seal is carried by the fluid system downstream from the fluid end inlet and configured to seal a space between the fluid end and an inner wall of the pipe. A motor having a rotor is supported to rotate on a second rotational axis and configured to reside external to the pipe. A magnetic coupling couples the rotor to the impeller to drive the fluid end via the motor. A second seal is carried by the fluid production system upstream from the fluid end inlet and configured to seal to the inner wall of the pipe.

Certain aspects encompass a method of flowing fluid in a pipeline. According to the method a fluid system is arranged within a conduit residing outside of a well and connected in the pipeline. The fluid system includes a fluid end inlet, a fluid end outlet, and an impeller arranged between the fluid end inlet and the fluid end outlet and supported to rotate on a first rotational axis. A first seal is carried by the fluid system downstream from the fluid end inlet and is configured to seal a space between the fluid end and an inner wall of the conduit. A motor including a rotor is supported to rotate on a second rotational axis and configured to reside external to the conduit. A magnetic coupling is configured to couple to the impeller to the motor to drive the fluid end via the motor. A second seal is carried by the fluid system upstream from the fluid end inlet and configured to seal to the inner wall of the conduit. The conduit is fluidically coupled in a pipeline arranged outside of the well, and fluid flow is driven, by the fluid system, in the conduit from the fluid end inlet toward the fluid end outlet.

Certain aspects encompass a fluid production system for a well. The fluid production system includes a fluid system configured to reside within a conduit residing outside the well. The fluid system includes a fluid end inlet, a fluid end outlet, and an impeller arranged between the fluid end inlet and the fluid end outlet and supported to rotate on a first rotational axis. A first seal is carried by the fluid production system downstream from the fluid end inlet and is configured to seal a space between the fluid end and an inner wall of the conduit. A motor including a rotor is supported to rotate on a second rotational axis, residing on an opposite side of the first seal from the fluid end, and is configured to reside external to the conduit. A coupling residing in a sealed coupling housing between the fluid end and the motor. The coupling rotationally coupling the impeller and rotor and the interior of the coupling housing maintained at a pressure configured to mitigate leakage of fluid from within the fluid end into the interior of the coupling housing. A second seal is carried by the fluid production system upstream from the fluid end inlet and configured to seal to the inner wall of the conduit proximate the magnetic coupling.

Certain aspects encompass a fluid production system including a plurality of pipes of a pipeline. The pipeline is fluidically connecting a wellhead to one or more destinations. The fluid production system includes a fluid system having a fluid end residing within a pipe of the plurality pipes and configured to connect inline in the pipeline. The fluid system includes a fluid end inlet, a fluid end outlet, and an impeller arranged between the fluid end inlet and the fluid end outlet and supported to rotate on a first rotational axis. A first seal is carried by the fluid system downstream from the fluid end inlet and configured to seal a space between the fluid end and an inner wall of the pipe. A motor having a rotor is supported to rotate on a second rotational axis and configured to reside external to the pipe. A coupling residing in a sealed coupling housing between the fluid end and the motor. The coupling rotationally coupling the impeller and rotor and the interior of the coupling housing maintained at a pressure configured to mitigate leakage of fluid from within the fluid end into the interior of the coupling housing. A second seal is carried by the fluid production system upstream from the fluid end inlet and configured to seal to the inner wall of the pipe.

Certain aspects encompass a method of flowing fluid in a pipeline. According to the method a fluid system is arranged within a conduit residing outside of a well and connected in the pipeline. The fluid system includes a fluid end inlet, a fluid end outlet, and an impeller arranged between the fluid end inlet and the fluid end outlet and supported to rotate on a first rotational axis. A first seal is carried by the fluid system downstream from the fluid end inlet and is configured to seal a space between the fluid end and an inner wall of the conduit. A motor including a rotor is supported to rotate on a second rotational axis and configured to reside external to the conduit. A coupling residing in a sealed coupling housing between the fluid end and the motor. The coupling rotationally coupling the impeller and rotor and the interior of the coupling housing maintained at a pressure configured to mitigate leakage of fluid from within the fluid end into the interior of the coupling housing. A second seal is carried by the fluid system upstream from the fluid end inlet and configured to seal to the inner wall of the conduit. The conduit is fluidically coupled in a pipeline arranged outside of the well, and fluid flow is driven, by the fluid system, in the conduit from the fluid end inlet toward the fluid end outlet.

The aspects above encompass some, none or all of the following features. In certain instances, the system includes a conduit with a first tubular portion around the fluid end outlet defining a first flow axis substantially aligned with the first rotational axis and a second tubular portion defining a second flow axis different from the first flow axis. The first seal can be arranged within the first tubular portion and the second seal can be arranged between the fluid end inlet and the motor and along the first rotational axis. In certain instances, the magnetic coupling includes a first coupling part that comprises a first magnet and a second coupling part that comprises a second magnet. A non-magnetic fluid barrier is arranged at least partly between the first coupling part and the second coupling part The first magnet and the second magnet produce a magnetic field that extends between the first magnet and the second magnet across the non-magnetic fluid barrier. The second seal is then between the first coupling part and the second coupling part. The rotor can be directly coupled to the first coupling part and the impeller can be directly coupled to the second coupling part. In certain instances, none of the motor, the fluid end, the first seal, the second seal, or the magnetic coupling have a rotating seal. The second rotational axis can coincide with the first rotational axis. In certain instances, the fluid end is a multiphase fluid end configured to drive axial flow of multiphase fluid through the conduit in the direction of the first rotational axis. In certain instances a first magnetic radial bearing is provided and configured to support the impeller to the conduit. A second radial magnetic bearing is provided and configured to support the rotor to a stator of the motor. In certain instances, the motor is configured to rotate the impeller at 10,000 revolutions per minute or more. In certain instances, a hermetically sealed housing is provided with the motor arranged within the hermetically sealed housing. The hermetically sealed housing can be at least partly filled with an incompressible fluid or encapsulate. In certain instances, the conduit is arranged as a wye or a tee, and the fluid system resides in one leg of the wye or tee and the motor resides another leg of the wye or tee. In certain instances, a second conduit is removed from the pipeline, first mentioned the conduit is installed in place of the second conduit. In certain instances, the pipeline is configured to flow between a wellhead and a gathering station.

Certain aspects encompass a fluid production system having a plurality of pipes residing outside of a well at an offshore platform and a plurality of in-line multiphase fluid systems arranged within the plurality of the pipes. The plurality of in-line multiphase fluid systems include a motor in a hermetically sealed housing and comprising a power cable extending from the motor through the sidewall of the pipe, a fluid end coupled to the motor and having a fluid end inlet and a fluid end outlet. The fluid end configured to drive fluid in the pipe from the inlet to the outlet. A seal is carried by the fluid system downstream from the fluid end inlet and is configured to seal a space between the fluid end and an inner wall of the pipe. A magnetic coupling is configured to couple the fluid end and the motor to enable the motor to drive the fluid end.

Certain aspects encompass a method of driving fluid flow in a fluid production system. According to the method, a plurality of in-line multiphase fluid systems are arranged each within a pipe of a plurality of the pipes at an offshore platform. The plurality of in-line multiphase fluid systems include a motor in a hermetically sealed housing with a power cable extending from the motor through the sidewall of the pipe and a fluid end coupled to the motor and comprising a fluid end inlet and a fluid end outlet. The fluid end is configured to drive fluid in the pipe from the inlet to the outlet. A seal is carried by the fluid system downstream from the fluid end inlet and configured to seal a space between the fluid end and an inner wall of the pipe. A magnetic coupling is configured to couple the fluid end and the motor to enable the motor to drive the fluid end. The one or more of the in-line multiphase fluid systems are operated to drive fluid through one or more of the pipes.

The aspects above can include some, none or all of the following features. In certain instances, each of the plurality of pipes is positioned such that they cannot accommodate a fluid system that extends outside the profile of the pipe. In certain instances, a controller is configured to control operation of the plurality of in-line multiphase fluid systems to balance fluid flows or fluid pressures in two or more of the pipes. In certain instances, each of the plurality of pipes is connected to a common manifold. In certain instances, one or more of the plurality of pipes fluidically connect one or more wells to one or more of a processing plant, a compression unit, and a custody transfer meter. In certain instances, two or more of the pipes fluidically connect a source to a destination in parallel, and the two or more pipes comprise in-line multiphase fluid systems. In certain instances, a pipe of the plurality of pipes includes two or more of the in-line multiphase fluid systems arranged in series. In certain instances, the plurality of pipes are removable subsections of one or more pipelines. In certain instances, none of the motor, the fluid end, the seal, or the magnetic coupling comprise a rotating seal. In certain instances, the fluid system is configured to rotate the fluid end at 10,000 revolutions per minute or more. In certain instances, a pipe is removed from the offshore platform and replaced with a pipe comprising an in-line multiphase fluid system. In certain instances, two or more of the pipes are connected between a source and a destination in parallel, wherein the two or more pipes include in-line multiphase fluid systems. In certain instances, fluid is flowed through one pipe of the parallel pipes from the source to the destination while the other pipe is removed. In certain instances, two or more of the in-line multiphase fluid systems are arranged in series in one of the plurality of pipes. In certain instances, both the motor and the fluid end of a respective one of the in-line multiphase fluid systems reside entirely within the pipe. In certain instances, the offshore platform is a production platform.

The details of one or more implementations are set forth in the accompanying drawings and the description below. Other features and advantages will be apparent from the description and drawings, and from the claims.

### DESCRIPTION OF DRAWINGS

FIG. 1A is a schematic diagram of an example fluid system at a pipeline from a well.

FIG. 1B is another schematic diagram of the example fluid system of FIG. 1A.

FIG. 2 is a half cross-sectional view of an example in-line multiphase fluid system for the fluid system of FIGS. 1A and 1B.

FIG. 3 shows a cross-sectional view of an example electric motor.

FIG. 4A shows a cross-sectional view of another example in-line multiphase fluid system.

FIG. 4B shows a detail cross-sectional view of another example in-line multiphase fluid system.

FIG. 5 is a schematic diagram of an example fluid distribution system.

FIG. 6 is a schematic diagram of an example fluid distribution network.

### DETAILED DESCRIPTION

This disclosure describes fluid systems for use in pipes to boost fluid flow and pressure, which can increase production from associated wells. These systems, including pumps, compressors and/or blowers, are installed in the fluid flow stream.

The concepts herein relate to a fluid system that can be installed in-line in the pipes, wholly or partially within the pipe carrying the flow. In some implementations, the electrical components, e.g., motor, of the fluid system are separated from the fluid end portions of the fluid system.

Downhole fluid systems and surface compression systems are typically used to increase well production and pressure and flow in pipes for transportation to gathering lines, processing facilities, and end users. But typical fluid systems require using separators to reduce the liquid in the fluid to function properly. By installing the fluid system into the pipe that is transporting the fluid, as described herein, advantages are realized. An overall smaller footprint with flange-to-flange integration simplifies integration of the fluid system. The fluid system, if a pump or configured to accept multi-phase flow, as described herein is also able to handle liquids in the fluid flow without requiring separation. The fluid system is also portable as opposed to a large, externally mounted pump or compressor and its supporting equipment installation. Being in the pipe also offers much lower fluid leakage and thus emissions, such as from the fluids in the pipe being released into the surrounding atmosphere. The fluid systems herein also offer operational flexibility by allowing for varying speed and torque for altering suction and discharge pressures to optimize operation and production.

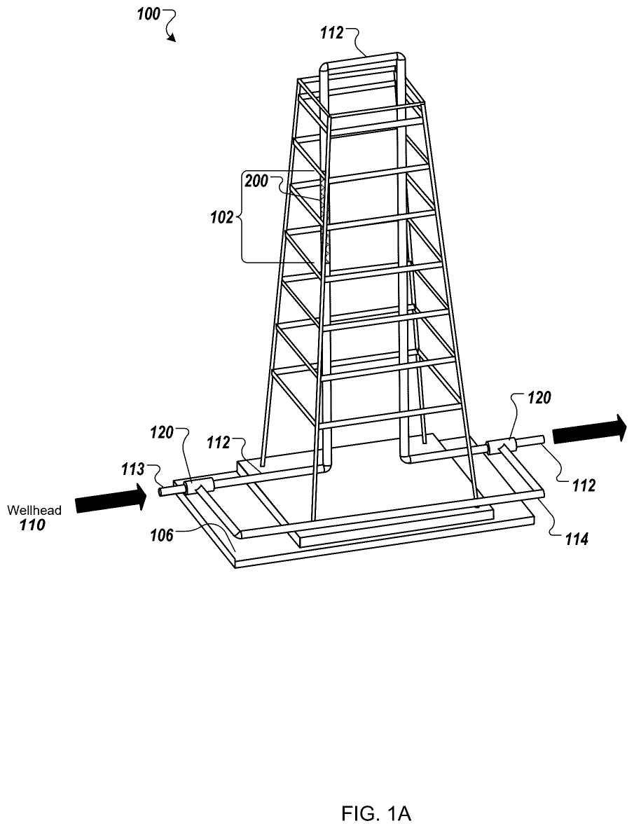

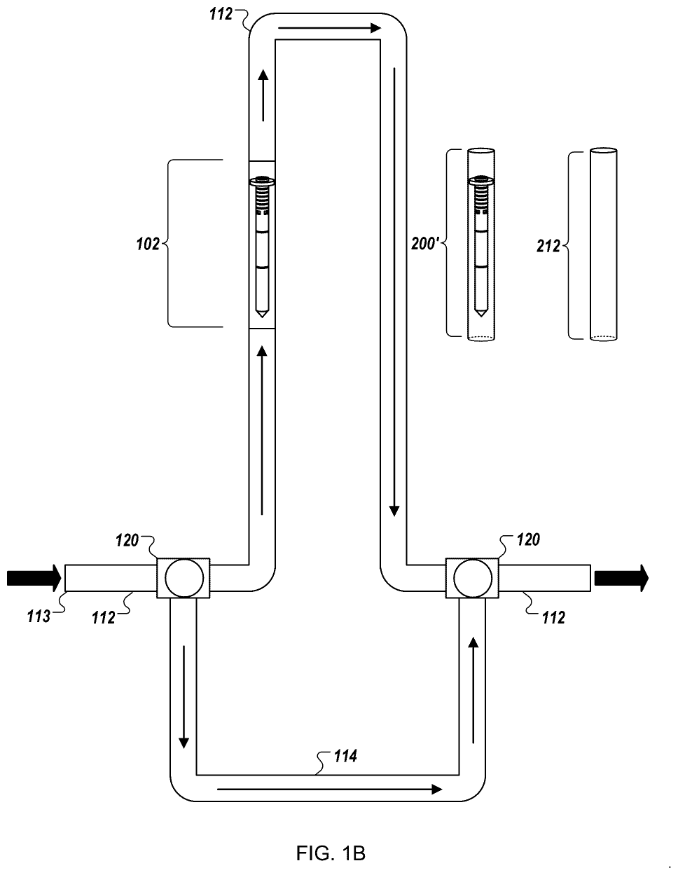

FIGS. 1A and 1B show a general arrangement of a well having a fluid system 102 in an associated surface pipe 112 in accordance with the concepts herein. In some implementations, the well is a gas well that is used in producing natural gas from the subterranean zones to a terranean surface 106. While termed a “gas well,” the well need not produce only dry gas, and may incidentally or in much smaller quantities, produce liquid including oil and/or water. In some implementations, the well is an oil well that is used in producing crude oil from the subterranean zones to the surface. While termed an “oil well,” the well not need produce only crude oil, and may incidentally or in much smaller quantities, produce gas and/or water. In some implementations, the production from the well can be multiphase in any ratio, and/or can produce mostly or entirely liquid at certain times and mostly or entirely gas at other times. For example, in certain types of wells, it is common to produce water for a period of time to gain access to the gas in the subterranean zone. The concepts herein, though, are not limited in applicability to gas wells, oil wells, or even production wells, and could be used in wells for producing other gas or liquid resources, and/or could be used in injection wells, disposal wells, or other types of wells used in placing fluids into the Earth.

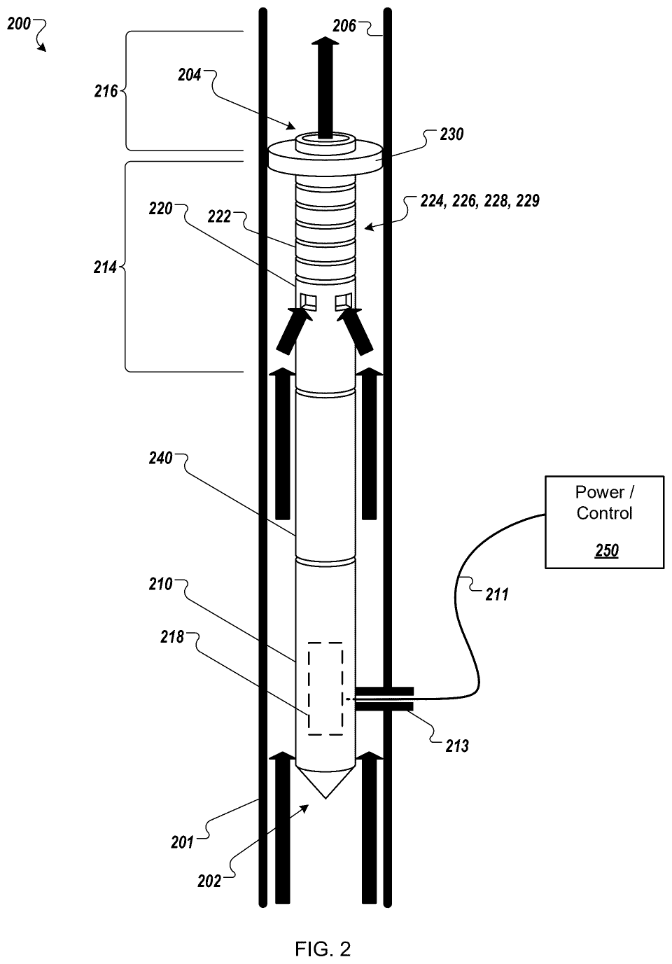

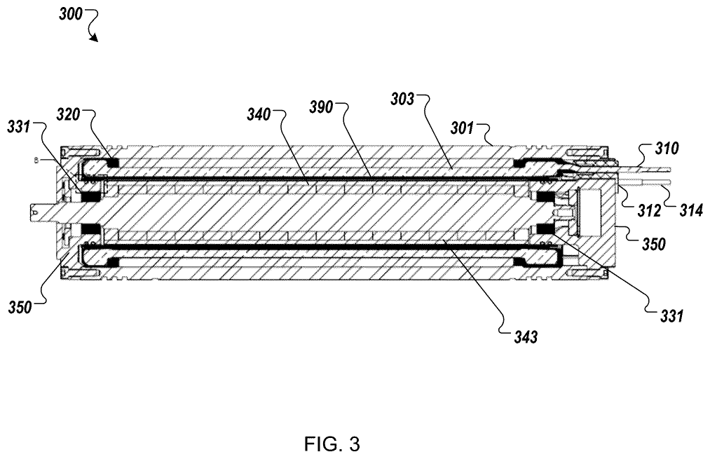

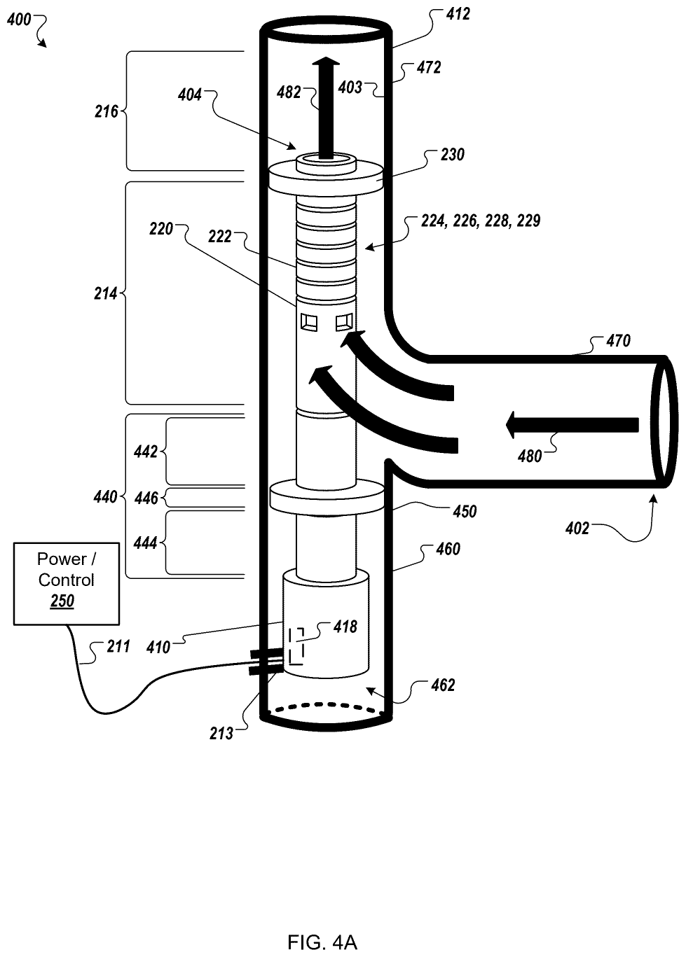

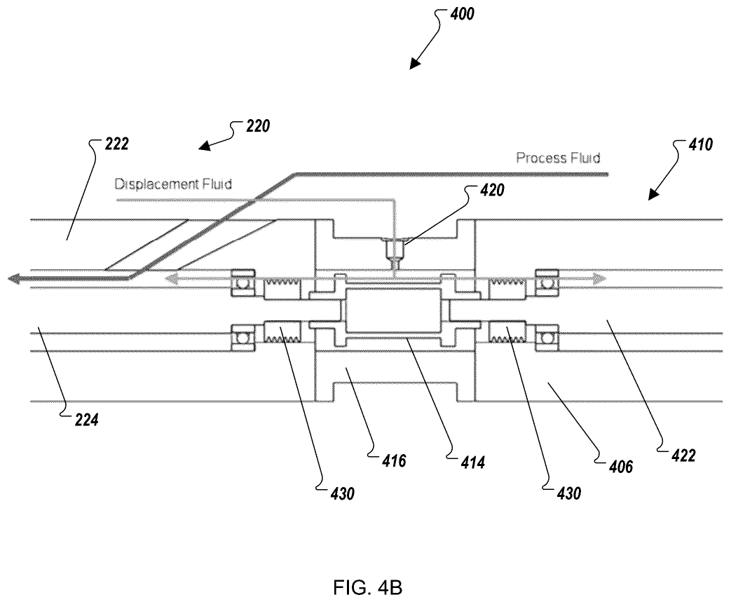

The wellhead 110 defines an attachment point for other equipment to be attached to the well. In certain instances, the well can be provided with a surface system 100 attached the wellhead 110. The surface system 100 includes a collection of piping 112 and valves 120 configured to direct fluid flow into or out of the well through the fluid system 102. While shown vertically, the surface system 100 can be arranged horizontally or at another angle relative to horizontal, and/or can be configured in a different arrangement of piping 112 and valves 120 as is show in in FIG. 1A. In certain instances, the fluid system 102 can include an in-line multiphase fluid system 200, such as a pump, compressor and/or blower, that will be discussed in more detail in the description of FIGS. 2-3 or an in-line multiphase fluid system 400 that will be discussed in more detail in the description of FIG. 4A. In other instances, the fluid system 102 can include another configuration of fluid system. The collection of valves 120 can also be configured to direct fluid flow around the fluid system 102 through a bypass pipe 114.

The piping 112 is not within the well, above ground, e.g., on or above the terranean surface, on the seabed, on a platform or other structure. In some embodiments, piping 112 can be a commercially produced piping. For example, the piping 112 can be constructed from pipes having a number of common sizes specified by the American Petroleum Institute (the “API) for use in surface (as opposed to downhole) application, or other, standard or non-standard pipe size. One or more portions of the fluid system 102 can be configured to fit in, and (as discussed in more detail below) in certain instances, seal to the inner diameter of one of the specified API, standard or non-standard pipe sizes. In some embodiments, one or more portions of the fluid system 102 can be made to fit in and, in certain instances, seal to other sizes of pipe or tubing. As shown in FIGS. 1A and 1B, one or more portions of the ends of the fluid system 102, and thus the in-line multiphase fluid system 200, can be attached in-line in the pipe 112.

In some embodiments, as will be discussed in more detail in the descriptions of FIGS. 4 and 8, portions of the fluid system 102 do not need to reside within the pipe 112 and can have dimensions that are larger than the inner diameter of the pipe 112. The largest outer diameter of the fluid system 102 may therefore be larger than the inner diameter of the pipe 112.

In some embodiments, the fluid system 102 can be arranged in a removable subsection of the pipe 112 to facilitate access to the fluid system 102. For example, the valves 120 can be used to route flow through the bypass pipe 114, bypassing the fluid system 102. With the flow and pressure bypassed, the section of the pipe 112 in which the fluid system 102 is arranged can be decoupled from the remainder of the pipe 112. While removed, the fluid system 102 can be accessed for repair, removal, or replacement and then the subsection can be rejoined to the pipe 112. In another example, the subsection that includes the fluid system 102 can be removed and readily replaced by a replacement subsection of pipe 212, and optionally a replacement fluid system 102′. Once the pipe 112 has been reassembled, the valves 120 can be reconfigured to direct flow away from the bypass pipe 114 and back through pipe 112 and the fluid system 102, the replacement fluid system 102′, or the pipe 212.

In some embodiments, two or more of the in-line multiphase fluid systems 102 can be arranged in parallel, so the flow can pass through one or the other fluid systems 102 independently. For example, the replacement fluid system 102′ can be installed in the bypass pipe 114. In an event in which the fluid system 102 is taken out of service, flow can be redirected to the replacement fluid system 102′ and the bypass pipe 114, and the replacement fluid system 102′ can be used to perform the operations normally performed by the fluid system 102.

In some embodiments, two or more of the in-line multiphase fluid systems 102 can be arranged in series, so the flow can pass through one fluid system 102 into another of the other fluid systems 102. In an event in which one of the fluid systems 102 fails or is taken out of service, flow can be continue to be driven through the second and/or additional fluid system 102 to continue to perform operations.

The fluid system 102 is configured to withstand and operate for extended periods of time (e.g., multiple weeks, months, years and/or another duration) at the pressures and temperatures experienced in the pipe 112, which temperatures can exceed 400° F./205° C. and pressures over 2,000 pounds per square inch, and while submerged in the pipe fluids (gas, water, or oil as examples). The fluid system 102 can also be configured to interface with one or more common connection systems, such as jointed tubing (that is, lengths of tubing joined end-to-end, threadedly and/or otherwise), coiled tubing (that is, not-jointed tubing, but rather a continuous, unbroken, and flexible tubing formed as a single piece of material).

Other implementations of the fluid system 102 can be utilized in conjunction with additional pumps, compressors and/or blowers, and combinations of these, in the pipeline to effect increased production. This fluid system 102 can be used at any stage of gas flow, from well head to end user pipes. The fluid system 102, since it is submerged in the process fluid, does not require the use of seals to prevent gas leakage to the environment. In some implementations, the fluid system 102 can be used as an alternative to a conventional topside fluid system, minimizing gas leakage to the environment and corresponding environmental impact, increasing reliability, and reducing power needed. Further examples of multiphase fluid systems with electric motors will be discussed in the descriptions of FIGS. 2-4.

The fluid system 102 is a fluid system that can locally alter the pressure, temperature, and/or flow rate conditions of the fluid in the well. In certain instances, the alteration performed by the fluid system 102 can optimize or help in optimizing fluid flow through the pipe 112. The fluid system 102 creates a pressure differential within the pipe 112, for example, particularly within the locale in which the fluid system 102 resides. The fluid system 102 introduced to the pipe 112 can reduce the pressure in an inlet pipe 113 of the pipe 112 to induce greater fluid flow from the well, increase a temperature of the fluid exiting the fluid system 102 to reduce condensation from limiting production, and/or increase a pressure in the pipe 112 downstream of the fluid system 102 to increase fluid flow in the pipe 112. The fluid system 102 can atomize and/or change characteristics of process fluid to allow for liquids to be transported to process station without separation. The fluid system 102 can be used to balance pressure to match with other wells connected to same flow line to optimize overall output.

The fluid system 102 moves the fluid at a first pressure upstream of the fluid system to a second, higher pressure downstream of the fluid system 102. The fluid system 102 can operate at and maintain a pressure ratio across the fluid system 102 between the second, higher downstream pressure and the first, upstream pressure in the pipe 112. The pressure ratio of the second pressure to the first pressure can also vary, for example, based on an operating speed of the fluid system 102.

Referring to FIG. 2, an example in-line multiphase fluid system 200 is described that can be implemented as fluid system 102. The in-line multiphase fluid system 200 includes an electric motor 210 that is rotationally coupled to an impeller 224 of a fluid end 220 by a coupler 240 residing in the fluid flow through the piping 112. The electric motor 210 is configured to drive the fluid end 220 to drive fluid flow from a fluid system inlet 202 toward a fluid system outlet 204 of the in-line multiphase fluid system 200. The fluid end 220, including its impeller, can be configured as a pump, compressor and/or a blower.

The electric motor 210, being of a type configured in size and of robust construction for installation within a pipe section 201, can be a part of or be used as any type of fluid system that can assist production of fluids at the surface 106 and out of the well by creating an additional pressure differential within the pipe 112 connected to the well.

In some embodiments, the pipe section 201 can be, or can be configured to fluidically couple to, a commercially produced piping. For example, the pipe section 201 can be constructed from pipes having a number of common sizes specified by the American Petroleum Institute (the “API), for example nominal 3, 3-½, 4, 4-½, 5, 6, 7, 8, 9, 10, 11, 12, 14, 16, 18 inches, or larger, and the API specifies internal diameters for each nominal pipe size. One or more portions of the in-line multiphase fluid system 200 can be configured to fit in and seal to the inner diameter of one of the specified API pipe sizes. The in-line multiphase fluid system 200 can also be configured to fit in and seal to other sizes of pipe, both standard and non-standard.

In some embodiments, the pipe section 201 can be a specially constructed conduit or other housing. For example, a cast or forged housing can include a bore or cavity that can define a fluid conduit, within which the in-line multiphase fluid system 200 can be arranged. In some embodiments, some or all of the in-line multiphase fluid system 200 and the surrounding pipe section 201 or conduit can be constructed as separate components or as a unitary structure. In some embodiments, the pipe section 201 can include built-in cooling lines, connector lines, oil circulation lines, instrumentation lines, or combinations of these and/or other appropriate fluid, electrical, and optical pathways.

The electric motor 210 includes a cable 211 connecting the electric motor 210 to a power and/or control source 250 at a local or remote location through the wall of the pipe 112 as shown, or in certain instances, passing through the seal system 230. A portion of the cable 211 can be ruggedized and sealed against ingress of fluid. For example, the cable 310 can be one or more wires that are embedded in a tube 213 or contained within a solid jacket or conduit that isolates the cable 211 and the ambient environment surrounding the pipe 112 from the fluids in the interior of the pipe 112, providing a hermetically sealed fluid conduit between a hermetically sealed housing of the electric motor 210 and the ambient environment surrounding the pipe 112. The cable 211 is connected to and configured to transmit power to a collection of internal electrical components 218 within the electric motor 210. In some embodiments, the cable 211 can be or include one or more communication busses (e.g., wires, optical fibers) connecting the internal electrical components 218 (e.g., sensors, switches, transmitters, receivers, other circuitry) of and/or associated with the electric motor 210 to the power and/or control source 250 (e.g., control electronics, sensor signal processors, communication transceivers, and/or other control sources) at a local or remote location.

In some embodiments, the tube 213 may be omitted, and the cable 211 itself can be configured for direct exposure to fluid. For example, an end of the cable can be hermetically sealed about an entry point to the motor, and another end of the cable 211 can pass through a static hermetic seal arranged in sealing contact between the electrical conductor and a port in the pipe section 201 to permit egress of the cable 211 from the in-line multiphase fluid system 200.

The fluid end 220 includes a housing 222 and a impeller 224 and a fluid stator 226 arranged within the housing 222. The impeller 224 can include a central rotating shaft 228 and one or more rotor stages 229 coupled to the central rotating shaft 228. In some embodiments, the rotor stages 229 define an axial fluid system. The fluid stator 226 can include a diffuser and can, for example, be attached to the housing 222. The in-line multiphase fluid system 200 can include a seal system 230 that is configured to create a seal between the outer surface of the fluid end 220 and the inner wall 206 of the pipe section 201, so that fluid cannot bypass the impeller 224 and fluid stator 226. The seal system 230 can couple to the pipe section 201 and prevent rotation of the fluid stator 226 while the impeller 224 rotates.

The seal system 230 divides the pipe section 201 into an upstream zone 214 before the seal system 230 and a downstream zone 216 after the seal system 230. In some embodiments, the seal system 230 can include a production packer. In some implementations, the seal system 230 may not be required.

In some embodiments, the seal system 230 can include an anchor with mechanical slips that can grip a smooth interior wall 206 of the pipe section 201. In some embodiments, the interior wall 206 can be provided with a profile and the anchor can include dogs that engage the profile. In certain instances, the seal system 230 can be affixed to the pipe section 201 via a flanged connection between two joints of the pipe section 201 and/or affixed in some other manner (e.g., welded, affixed with fasteners, affixed with a mount, and/or in another manner) to the pipe section 201. In some embodiments, the fluid end 220 can be free of electrical components. Also, notably, while the concepts herein are discussed with respect to fluid systems, they are likewise applicable to other types of pumps, compressors, blowers, and devices for moving multi-phase fluid, such as natural gas, hydrogen, helium, water, liquid petroleum products (e.g., oil), and combinations of these and/or other liquids and gasses.

The coupler 240 is configured to rotatably couple a rotational output of the electric motor 210 (e.g., rotation of a motor rotor) to the impeller 224 of the fluid end 220. In some embodiments, the coupler 240 can be a direct drive coupler configured to drive the impeller 224 to rotate at the same speed as the motor 210 (e.g., the motor rotor). In some embodiments, the in-line multiphase fluid system 200 can include a gearbox that provides a speed reduction or multiplication.

In some embodiments, the rotational coupling can be mechanical. For example, a rotor shaft of the electric motor 210 can be fastened to the fluid end 220, or can include splines or gear teeth that intermesh with complimentary splines or gear teeth of the impeller 224 such that rotational output of the electric motor 210 can drive rotational motion of the impeller 224.

In some embodiments, the rotational coupling between the electric motor 210 and the fluid end 220 can be magnetic. For example, the coupler 240 can be a magnetic coupler in which rotational output of the electric motor 210 can drive rotation of a magnet, and the impeller 224 can be affixed to a complimentary magnet arranged such that rotation of one magnet (e.g., by the electric motor 210) and its magnetic fields can drive similar rotation of the complimentary magnet to drive rotation of the impeller 224 and rotors 229. In some embodiments, the magnet pair can be fluidically separated by a magnetically permeable and fluid impermeable barrier. For example, the coupler 240 can be configured as a non-magnetic fluid barrier made from materials such as stainless steel, titanium, ceramic, or carbon fiber, as such material can reduce or avoid hysteresis and reduce or avoid eddy current losses generated in the material due to the varying magnetic fields. In some implementations, the electric motor 210 can be magnetically coupled to the fluid end 220 across a fluid barrier, for example, to fluidically seal, separate, and/or protect the electric motor 210 from exposure to the fluids that contact the fluid end 220. In the illustrated example, none of the electric motor 210, the fluid end 220, the seal system 230, or the magnetic coupler 240 implement a rotating seal. However, this is not to say that rotating fluid seals need be wholly avoided, nor that the concepts here cannot apply to systems with rotating fluid seals.

The in-line multiphase fluid system 200 can operate at a variety of speeds, for example, where operating at higher speeds increases fluid flow, and operating at lower speeds reduces fluid flow. In some implementations, the electric motor 210 can operate at speeds including and in excess of 10,000 revolutions per minute (rpm). In some implementations, the electric motor 210 can operate at lower speeds (for example, 5,000 rpm). Specific operating speeds for the electric motor 210 can be defined based on the fluid (in relation to its composition and physical properties) and flow conditions (for example, pressure, temperature, and flow rate) for the well parameters and desired performance. While the in-line multiphase fluid system 200 can be designed for an optimal speed range at which the fluid system inlet 202 performs most efficiently, this does not prevent the in-line multiphase fluid system 200 from running at less efficient speeds to achieve a desired flow for a particular pipeline, as well characteristics change over time.

The in-line multiphase fluid system 200 can operate in a variety of upstream conditions of the well. For example, the initial pressure of the well can vary based on the type of well, depth of the well, production flow from the perforations into the well, and/or other factors.

In some embodiments, the electric motor 210 can be configured to passively transfer heat energy to fluid that flows around and through the in-line multiphase fluid system 200. For example, during operation, the electric motor 210 can generate heat as a byproduct of its operation. The electric motor 210 can be configured to conduct such heat energy to its peripheral surface and to surrounding fluid(s) in the pipe section 201. Fluid flow driven by the fluid end 220 can cause the heated fluid(s) to move away from the electric motor 210 and bring relatively cooler fluid(s) into contact with the peripheral surface. In some embodiments, the electric motor 210 can include one or more passive heat exchangers, such as cooling fins, to enhance heat transfer from the electric motor 210 to the surrounding fluid(s). As an alternative to or in addition to the passive heat transfer, a cooling jacket can be employed on or in the motor 210, through which coolant cooled via an external cooling system can be circulated.

FIG. 3 shows a cross-sectional view of an example electric motor 300. In some embodiments, the electric motor 300 can be the example electric motor 210 of FIG. 2. The electric motor 300 is configured to be positioned in a pipe (such as the pipe section 201). The electric motor 300, shown in half cross-sectional view, includes an electromagnetic stator 303 encased in a housing 301. The housing 301 can be, in certain instances, encapsulated in epoxy or flooded with an incompressible fluid as an encapsulation 320. The housing 301 is configured to slip into the pipe section 201. The electric motor 300 includes an motor rotor 340 that is configured to be positioned within the electromagnetic stator 303 and configured to be driven by the electromagnetic stator 303. The motor rotor 340 can be coupled to an impeller (e.g., the example impeller of fluid end 220 of FIG. 2).

In certain instances, an inner sleeve 390 can be provided on the electromagnetic stator 303 and the motor rotor 340 and, as discussed below, seals the electromagnetic components of the stator 303 from the motor rotor 340 and fluid around the motor rotor 340. In some embodiments, the effects of the larger rotor/stator gap can be offset by increasing the amount of power that is provided to the electromagnetic stator 303 in order to generate magnetic fields that reach over such larger clearances. As discussed in more detail below, such an inner sleeve 390, however, can be omitted in certain instances.

In some embodiments, the sleeve 390 can be made of a non-magnetic material with high electrical resistivity, such as stainless steel, titanium, or non-metallic materials such as ceramic, or carbon fiber, can be used, as such material can reduce or avoid hysteresis and reduce or avoid eddy current losses generated in the material due to the varying magnetic fields. While metallic materials can optionally be used to fabricate the sleeve 390, non-magnetic materials can typically provide better efficiency and electric motor 300 performance.

In some embodiments, such as upstream applications where the components can be subject to high pressures in a caustic environment, the sleeve materials can be chosen to meet operational life requirements. The high pressure experienced by the sleeve 390 is typically due to its exposure to production fluids in the pipe section 201 that pass through the dynamic seals supporting the motor rotor 340. In some embodiments, the structural strength requirements of the sleeve 390 can be reduced in order increase the available options for materials that can be used in the construction of the sleeve 390. For example, some ceramics and other non-metallic materials may be compatible with caustic environments but may be limited in structural strength (e.g., in comparison to metallic materials or may be sufficiently strong but may lack environmental or durability requirements). In order to use such non-metallic materials for the benefit of the operation of the electric motor 300, an encapsulation or liquid filled housing 301 may be used. For example, the housing 301 and sleeve 390 can be supported such that they do not need to fully support the load produced by the pressure differential between pipe fluid and interior of the electric housing. Such loads can be carried by the encapsulation and stator itself, which can be more suitable for some high loads. In such implementations, the sleeve 390 can be designed to be compatible with the environment characteristics without needing to be designed for increased structural strength (which can require increased thickness). Therefore, the clearance between the motor rotor 340 and the electromagnetic stator 303 can be reduced (thereby increasing power efficiency of the electric motor 300) and non-metallic materials (such as carbon fiber and ceramics) can be used for the sleeve 390. In some embodiments, metallic materials (such as Inconel or titanium) can optionally be used.

If flooded, the incompressible fluid can, for example, be a dielectric fluid that floods the electrical components encased within the housing 301 (such as the electromagnetic stator 303). In some implementations, the incompressible fluid is pressurized, which can reduce the differential pressure loads across the housing 301.

The incompressible fluid can also conduct heat from electromagnetic stator 303 components (such as windings) to the housing 301, to the fluid in the pipe outside of the housing 301, to a cooling fluid flowed through the motor, or any combination of these. In some embodiments, the housing 301 can include built-in cooling lines, connector lines, oil circulation lines, instrumentation lines, or combinations of these and/or other appropriate fluid, electrical, and optical pathways.

The electric motor 300 includes a cable 310 connecting the electromagnetic stator 303 to a power source at a local or remote location. That portion of the cable 310 can be ruggedized and sealed against ingress of fluid. For example, the cable 310 can be one or more wires that are embedded in a metal tube or contained within a metal jacket that isolates the cable 310 from fluid. The cable 310 can be connected to and transmit power to multiple electrical components within the housing 301. In some embodiments, the cable 310 can be or include one or more communication busses (e.g., wires, optical fibers, and/or other bus) connecting internal components (e.g., sensors, switches, transmitters, receivers, other circuitry) of the electric motor 300 to power and/or data sources (e.g., control electronics, sensor signal processors, communication transceivers and/or other power and/or data sources) at a local or remote location.

In some implementations, the electric motor 300 can include a cooling port 312 for connecting to a cooling tube 314. The cooling port 312 can be sealed against ingress of other fluids into the housing 301. A cooling tube 314 can connect the housing 301 to a coolant source at a local or remote location. The coolant can be provided from the coolant source and be circulated through the housing 301 to provide cooling to the electromagnetic stator 303. The circulating coolant can remove heat generated by operation of the motor from various components (or a heat sink) within the housing 301. In some implementations, the coolant floods the inner volume of the housing 301 within which the electromagnetic stator 303 resides. In some implementations, the coolant circulates within portions of the housing 301 where heat dissipation to the well fluid (for example flowing past the inner bore of the housing 301) is limited. The coolant circulating through the housing 301 can lower the operating temperature of the housing 301 (which can help to extend the operating life of the electric motor 300), particularly when the surrounding temperature of the environment would otherwise prevent the electric motor 300 from meeting its intended operating life.

In some implementations, the housing 301 includes a jacket through which the coolant can circulate to remove heat from the electromagnetic stator 303 and/or other components within the housing 301. In some implementations, the jacket is in the form of tubing or a coil positioned within the housing 301 through which the coolant can circulate to remove heat from the electromagnetic stator 303 and/or other components within the housing 301. In some implementations, the coolant can be isolated within the jacket and not directly interact with other components within the housing 301. In such implementations, the housing 301 is not flooded by the coolant. In some implementations, coolant does not circulate through the housing 301 (that is, coolant is not continuously supplied from the coolant source to the housing 301). Instead, one or more portions of the housing 301 are simply flooded with coolant without the coolant flowing into or out of the housing 301 during operation of the electric motor 300. The coolant within the housing 301 can be isolated from portion(s) of the housing 301 that are encapsulated or flooded by other incompressible fluid. In some implementations, the coolant may not be necessary, as heat from the electric motor 300 can be dissipated to its surrounding environment (for example, by the flow of fluid through an annulus between the housing and the pipe.

The electromagnetic stator 303 encased within the housing 301 can include a magnetic field source, such as an electromagnetic coil windings. The electromagnetic coil windings can be connected to the cable 310, and in response to receiving power, the electromagnetic coil windings can generate a magnetic field to drive the motor rotor 340. The motor rotor 340 can include one or more permanent magnets 343. The electromagnetic coil windings and the permanent magnets 343 can interact magnetically. The electromagnetic coil windings and the permanent magnets 343 can each generate magnetic fields that impart forces that cause the motor rotor 340 to rotate.

In some embodiments, the electric motor 300 can include one or more bearings. For example, the bearings can be configured to control the radial and/or axial position of the motor rotor 340 with respect to the housing 301. In the case of a magnetic bearing, the magnetic bearing can include a magnetic bearing actuator and a magnetic bearing target. The magnetic bearing actuator and the magnetic bearing target can be configured to cooperate and interact magnetically to control levitation of the rotor 340. The electric motor 300 can include one or more magnetic bearing actuators 331 affixed to the housing 301. In some embodiments, the magnetic bearing actuators 331 can be permanent magnets (e.g., passive) and/or electromagnetic coils (e.g., active or passive with active control). In examples in which the magnetic bearing actuators 331 include electromagnetic coils, they can be connected to the cable 310. In some embodiments, the bearings can be mechanical oil-lubricated, where lubrication fluids present in the gas stream can be carried and separated in downstream processing, or the lubrication fluids can be recirculated with lubricant loss being compensated for by an external supply. In some embodiments, the bearings can be air bearings. In some embodiments, the electric motor can use mechanical bearings, such as ball bearings, instead of or in combination with magnetic bearings to provide support and/or axial thrust support of the rotor.

The sleeve 390 is configured to seal, and thus protect, the electromagnetic stator 303 from the fluid being flowed through the piping. The non-metallic inner sleeve 390 can include ceramic material, carbon fiber composite, or combinations these and/or any other appropriate material. The sleeve 390 can be a non-magnetic material, a material that is not magnetically conductive but may or may not be electrically conductive, so as to reduce or minimize unwanted motor magnetic field conduction (e.g., to prevent conduction of the magnetic fields in the sleeve 390 versus through the sleeve 390) and/or reduce or minimize eddy currents. In some embodiments, use of an encapsulated electric stator or liquid flood electric stator can reduce the strength requirement of the sleeve 390 by providing support of the sleeve when the pressure of the fluid is higher than that in the electric stator housing. The encapsulation therefore can allow the thickness of the sleeve 390 to be decreased in comparison to an electric motor without such a sleeve 390, and/or the choice of material to fabricate the sleeve 390 does not have to depend on strength/structural support. In some embodiments, reduction of thickness of the sleeve 390 (and material selection for the sleeve 390) can reduce the cost of materials, can reduce eddy currents, and/or can allow for a larger inner bore size of the housing 301, such that other components of the electric motor 300 can be larger and occupy the increased space, thereby increasing the power density of the electric motor 300.

In some implementations, the sleeve 390 can be omitted. For example, the housing 301 can be sealed to protect the internal components from fluid intrusion. Use of a magnetic coupling as described herein enables use of a static seal to seal the housing 301, ensuring a robust enough seal that the stator 303 and, more generally the interior of the motor, is isolated from the process fluid.

The sleeve 390 is connected at each end-to-end bells 350 that form the ends of the housing 301. These end bells 350 can provide support for bearings that in turn support the motor rotor 340 and allow the motor rotor 340 to rotate freely when torque is provided by the electromagnetic stator 303. At the connection of the sleeve 390 to the end bell 350 seals (e.g., O-rings and/or another type of seal) are provided to prevent fluid from entering the electromagnetic stator 303 area. Additionally, or alternatively (e.g., instead of seals), the connection can be a welded or bonded feature to prevent fluid from entering the electromagnetic stator 303. In some embodiments, the electromagnetic stator 303 can act as a secondary seal to a bore seal in case of bore seal failure, yet still provide some or all the benefits of having the stator external to the fluid flow.

FIG. 4A shows a cross-sectional view of another example in-line multiphase fluid system 400. In general, the in-line multiphase fluid system 400 is similar to the example in-line multiphase fluid system 200 of FIG. 2, except as noted below. Likewise, the in-line multiphase fluid system 400 can be incorporated as fluid system 102. Whereas the electric motor 210 of the in-line multiphase fluid system 200 is arranged entirely within the pipe section 201, the in-line multiphase fluid system 400 is configured with a motor 410 that is arranged outside of a conduit 412 and a fluid end within the conduit 412 (e.g., a pipe or other housing that defines a chamber). The in-line multiphase fluid system 400 can be a part of or be used as any type of fluid system that can assist production of fluids at the surface and out of the well (e.g., the surface 106 and the well of FIG. 1A) by creating an additional pressure differential within the conduit 412 connected to the well. In some implementations, the in-line multiphase fluid system 400 can be used in place of, or in combination with, the in-line multiphase fluid system 200.

In some embodiments, the conduit 412 can be a pipe or other housing. For example, a cast or forged housing can include a bore or cavity that can define a fluid conduit, within which the in-line multiphase fluid system 400 can be arranged. In some embodiments, some or all of the in-line multiphase fluid system 400 and the surrounding conduit 412 or conduit can be constructed as separate components or as a unitary structure.

In some embodiments, the conduit 412 can be, or can be configured to fluidically couple to, a commercially produced piping. For example, the conduit 412 can be constructed from pipes having a number of common sizes specified by the American Petroleum Institute (the “API). One or more portions of the in-line multiphase fluid system 400 can be configured to fit in and seal to the inner diameter of one of the specified API pipe sizes.

In some embodiments, some or all of the in-line multiphase fluid system 400 and the surrounding conduit 412 can be constructed as separate components or as a unitary structure. In some embodiments, the conduit 412 can include built-in cooling lines, connector lines, oil circulation lines, instrumentation lines, or combinations of these and/or other appropriate fluid, electrical, and optical pathways.

The conduit 412 can be configured as a Y (wye) or a T (tee), having flow path inlet 402 defined by a tubular portion 470 of the conduit 412 coupled to an outlet 404 defined by a tubular portion 472 of the conduit 412. The flow flows through the tubular portion 470 along a center longitudinal/flow axis 480 that is arranged at a right or non-zero angle relative to a center longitudinal/flow axis 482 in tubular portion 472. Although shown with the tubular portion 470 horizontal and the tubular portion 472 vertical, the fluid system 400 (and conduit 412) can be in a different orientation, such as with the tubular portion 470 vertical or another orientation. Likewise the angle between the tubular portion 470 and tubular portion 472 is shown as approximately 90°, the angle can alternatively be obtuse or acute.

The motor 410 is rotationally coupled to the fluid end 220 by a coupler 440 at a port 450 of the conduit 412. The motor 410 is configured to drive the fluid end 220 through the coupler 440 to drive fluid flow from the inlet 402 of the conduit 412 toward the outlet 404 of the in-line multiphase fluid system 400. The coupler 440 is configured to rotatably couple a rotational output of the motor 410 (e.g., a motor rotor) to drive the impeller 224 of the fluid end 220.

The coupler 440 includes an upper portion 442 residing in the fluid flow and a lower portion 444 residing out of the fluid flow, separated by a seal 446. The seal 446 can seal to the inner wall of the conduit 412 at the port 450 and reduce or prevent egress of fluid out of the conduit 412 at the port 450. In some embodiments, the seal 446 can include an anchor with mechanical slips that can grip an inner wall 403 of the conduit 412 and/or dogs that engage a profile in the inner wall 403 of the conduit 412.

The motor 410 is magnetically coupled to the fluid end 220 across the seal 446, which acts as a fluid barrier, for example, to fluidically seal, separate, and/or protect the motor 410 from exposure to the fluids that contact the fluid end 220. In some embodiments, the seal 446 can be a packer seal. In some embodiments, the seal 446 can be a solid and/or unitary (e.g., permanent) part of the conduit 412. For example, the seal 446 and the conduit 412 can be formed as a single, unitary piece of material, or the seal 446 can be a cap or plug that is welded or otherwise attached or adhered to the conduit 412 to form a fluid-tight seal.

As shown in FIG. 4B, the motor 410 can alternately be coupled to the fluid end 220 via a mechanical coupling 414 affixed to the impeller 224 of the fluid end 220 and the rotor 422 of the motor 410. In FIG. 4B, the coupling 414 is a direct coupling, configured so that the impeller 224 and motor rotor 422 are directly coupled to rotate at the same speed. The coupling 414 can be rigid or flexible (e.g., allowing angular misalignment). In some instances, the coupling 414 can include a gear reduction/multiplier, so that the impeller 224 and motor rotor 422 rotate at different speeds.

The depicted coupling 414 is housed inside of a coupling housing 416 affixed to and sealed to the fluid end housing 222 and the motor housing 406 to define an internal chamber, where the internal chamber is sealed against entry of process fluids that are flowing around the exterior of the fluid system 400. The fluid system 400 incorporates seals 430 sealing between the fluid end housing 222 and the impeller 224 and sealing between the motor housing 406 and the motor rotor 422, so as to mitigate or prevent fluid exchange between the cavity within the coupling housing 416 and each of the fluid end 220 and the motor 410. The coupling housing 416 has a port 420 that can be coupled to a source of displacement fluid that is supplied into the cavity to pressurize the cavity to a specified pressure. The source of displacement fluid can be within a housing of the fluid system 400, e.g., a dedicated housing, the fluid end housing 222 or the motor housing 406, or provided exterior to the fluid system 400 proximate to the fluid system or remote (e.g., inside or outside of the shell 460) from the fluid system. In certain instances, the specified pressure can be configured to mitigate or prevent leakage of process fluid from an interior of the fluid end 220 into the cavity of the coupling housing 416. In certain instances, the pressure in the cavity of the coupling housing 416 is at, approximately at (e.g., within 5%, 10% or 15% of the process fluid pressure), or above the pressure of the process fluid where it enters the fluid end 220 (e.g., proximate (at or near) the fluid end inlet) and/or within the fluid end 220 proximate (at or near) the seal 430 to prevent leakage of process fluid that enters the fluid end 220 into the cavity. Thus, any leakage through the seals 430 will be leakage of the displacement fluid out of the cavity into the fluid end 220 or into the motor 410. In other words, the displacement fluid supplied to the cavity of the coupling housing 416 acts as a fluid barrier, for example, to fluidically seal, separate, and/or protect the motor 410 from exposure to the process fluids in the fluid end 220. The displacement fluid prevents process fluid from leaking into the motor 410. The configuration allows the interior of the motor housing 406 to be maintained at a lower pressure than the process fluids, which can reduce windage losses generated from the rotating motor rotor 422. While a multitude of different fluids can be used as the displacement fluid, in certain instances, the displacement fluid is a neutral or inert (nearly or entirely inert) gas. An example of one such gas is nitrogen. Of note, although described in connection with the fluid system 400 of FIG. 4A, the same configuration of coupling 414 within a pressurized coupling housing 416 and with sealed impeller 224 and motor rotor 422 can be used with any configuration according to the concepts described herein, including the configurations of FIGS. 1A-3 and 5-6.

Referring back to FIG. 4A, the motor 410 and the outer portion 444 are separated from the flow path by the seal 446 such that the flow does not pass to the motor 410. This separation allows for use of an external cooling jacket on the motor 410 without limiting the fluid flow path. Since components associated with the motor 410 are not exposed to process fluids, the options for the materials used in their construction can be expanded (e.g., not limited to materials that are compatible with the process fluid). Such an arrangement also allows for servicing the motor 410 or the sealed section separately from the fluid end 220 section of the in-line multiphase fluid system 400.

The motor 410 includes the cable 211 connecting the motor 410 to the power and/or control source 250 at a local or remote location. That portion of the cable 211 can be ruggedized and sealed against ingress of fluid. The cable 211 connected to and configured to transmit power to a collection of internal electrical components 418 within the motor 410. In some embodiments, the cable 211 can be or include one or more communication busses (e.g., wires, optical fibers and/or other busses) connecting the internal electrical components 418 (e.g., sensors, switches, transmitters, receivers, other circuitry and/or other components) of the motor 410 to the power and/or control source 250 at a local or remote location.

The coupler 440 is a magnetic coupler in which rotational output of the motor 410 can drive rotation of a magnet, and the rotors 229 can be affixed to a complimentary magnet arranged such that rotation of one magnet (e.g., by the motor 410) and its magnetic fields can drive similar rotation of the complimentary magnet to drive rotation of the rotors 229. The magnet pair is fluidically separated by a magnetically permeable fluid barrier. For example, the coupler 440 can be partly made of non-magnetic material such as stainless steel, titanium, ceramic, or carbon fiber. The motor 410 is magnetically coupled to the fluid end 220 across the seal 446 to fluidically seal, separate, and/or protect the motor 410 from exposure to the fluids that contact the fluid end 220.

In the illustrated example, the seal 446 is a substantially static seal. With the motor 410 and the fluid end 220 magnetically coupled, only the rotation of magnetic flux is used in order to transmit torque from the motor 410 to the fluid end 220 across the seal 446. The exterior of the coupler 440 itself does not rotate relative to the conduit 412. As such, sealing contact between the seal 446, the inner wall 403, and the coupler 440 is static. In some examples, a static seal can provide improved sealing relative to a dynamic, rotational seal since there is no moving contact that can cause wear and, by extension, an eventual need for repair or replacement in order to prevent leakage. In some embodiments, the seal 446 can be formed as an integral, unitary part of the coupler 440 and/or the conduit 412. In some embodiments, the seal 446 can be bonded to or otherwise unified with (e.g., welded and/or otherwise joined) the coupler 440 and/or the conduit 412 to form a substantially seamless and substantially leak-proof assembly. In some embodiments, a rotating seal can be used. In some embodiments, none of the motor 410, the fluid end 220, the seal 446, or the magnetic coupler 440 can include a rotating seal.

In some embodiments, the motor 410 can be positioned in a portion of the conduit 412 that extends to the side, another tubular or conduit arranged as a leg of a Y (wye) or T (tee) with the conduit 412, or the motor can be arranged within a shell 460 coupled to or apart from the conduit 412. The shell and/or conduit defines a cavity 462 for enclosing the motor 410. In some embodiments, the shell 460 can be configured to protect and substantially seal the motor 410 from the ambient environment. For example, the shell 460 can protect the motor 410 from rain or other water intrusion (e.g., seawater, spray washing), dust, debris, or physical impact. In some embodiments, the shell 460 can be configured to protect and substantially insulate the motor 410 from the ambient environment. For example, the shell 460 can include insulation and/or thermally reflective shielding.

In some embodiments, the motor 410 and outer portion 444 can be sealed in an ambient pressure environment within the cavity 462, lower than that of the process fluid. For example, the cavity 462 can be open at its end or, in some embodiments, the cavity 462 can be partly or entirely filled and/or pressurized with nitrogen to minimize windage losses of the motor 410. The sealed section can be purged once the seal 446 can be set to allow for pressurizing with nitrogen to prevent the process fluid(s) from leaking into the cavity 462. The cavity 462 can be bled to ambient pressure to allow for servicing of the motor 410. In some implementations, pressure reset of the motor 410 can be done if internal pressure rises, as only dry nitrogen is surrounding this section of the tool.

In some embodiments, the shell 460 can be configured to cool the motor 410. For example, the shell 460 can include passive cooling elements such as fins configured to radiate heat from the motor 410 to the ambient environment. In another example, the shell 460 can include active cooling elements, such as elements of a heat exchanger in which a coolant fluid is circulated through a closed fluid loop about the motor 410 within the shell 460 to absorb heat energy, and is then circulated outside of the shell 460 (e.g., through a radiator or intercooler) to radiate the heat energy to the ambient environment. In another example, the shell 460 can be at least partly flooded with a coolant (e.g., glycol, water, oil and/or other coolant) to help conduct heat away from the motor 410.

In some embodiments, the shell 460 can be a fluidically sealed and/or pressurizable vessel. For example, the motor 410 can be coupled to the coupler 440. The shell 460 can then be coupled to the conduit 412 at the port 450, fluidically sealing the motor 410 inside the cavity 462. The cavity 462 can then be pressurized with a gas or liquid such that a pressure differential between the pressure of fluid in the interior of the conduit 412 and the pressure of fluid in the cavity 462 across the seal 446 is substantially zero, for example, to resist leakage of process fluids from within the conduit 412 across the seal 446 and into contact with the motor 410. In some implementations, the cavity 462 can be charged (e.g., with a neutral gas or liquid such as air, nitrogen, water and/or another fluid) to a pressure that exceeds the fluid pressure within the conduit 412. In such examples, leakage (if any) will flow away from the motor 410 across the seal 446 and be carried away by the process fluid. In some implementations, whether the cavity 462 is equal to or below the pressure of the fluid in the interior of the conduit 412, the cavity 462 can be coupled to a source of fluid that is circulated in and out of the cavity allowing any process fluid that leaks into the cavity to be removed and not substantively impact the motor 410 operation.

In some embodiments, the shell 460 can include one or more sensors. For example, the shell 460 can include temperature sensors configured to provide signals representative of temperatures within the cavity 462. In another example, the shell 460 can include a pressure sensor configured to provide signals representative of fluid pressures within the cavity 462. For example, an elevation of pressure within the cavity 462 can be indicative of an incursion of fluid from the conduit 412 into the shell 460, or a loss of pressurization of the cavity 462, indicative of a possible malfunction of the seal 446 and a need for inspection and/or service. In another example, the shell 460 can include a fluid sensor configured to provide signals that indicate a presence to absence of fluid within the cavity 462, which may be indicative of a possible malfunction of the seal 446.

In some embodiments, the shell 460 can include a drain port. For example, the shell 460 can be configured as a safety catch can to temporarily retain process fluid that may have leaked past the seal 446 and prevent the leaked fluid from escaping to the surrounding environment. The drain port can then be used to drain leaked fluids from the cavity 462 into a container for proper disposal.

In some embodiments, the shell 460 can be omitted. For example, the motor 410 may be substantially exposed to the ambient surrounding environment, instead depending on the seal 446 to prevent process fluid leaks. In such examples, the motor 410 can be fully available to monitor, service, and replace without impacting production fluid flow and/or connections. Since the motor 410 resides outside of the conduit 412 in such examples, pipe size does not substantially limit the design size of the motor 410.

In some embodiments, the rotational coupling can be mechanical. For example, a rotor shaft of the motor 410 can be fastened to the fluid end 220, or can include tines or gear teeth that intermesh with complimentary tines or gear teeth of the rotors 229 such that rotational output of the motor 410 can drive rotational motion of the fluid end 220. The seal 446 can be a dynamic or rotary seal that fluidically seals against the rotor shaft while allowing rotation of the rotor shaft. In some examples, this arrangement could allow part or all of the motor 410 to be isolated from the process fluids and flow path and have a cooling jacket.

In some embodiments, the in-line multiphase fluid system 400 can include a gearbox. For example, the coupler 440 or the motor 410 can include a gear-reduction assembly such that high-RPM motors can be usefully coupled to impellers designed for lower-RPM operations. In another example, the coupler 440 can include a speed increaser gearbox such that low-RPM motors can be usefully coupled to impellers designed for high-RPM operations.

With the motor 410 arranged outside of the conduit 412, various sizes of motors can be used. For example, the motors having diameters that are larger than the inner diameter of the pipe 112 and/or the conduit 412 can be used (e.g., higher power motors than may be available in sizes that fit within the pipe 112 and/or the conduit 412. With the motor 410 arranged outside of the conduit 412, various types of motors can be used. For example, the coupler 440 can couple the fluid end 220 to a crankshaft of a combustion engine or a rotor shaft of a turbine engine. In another example, the coupler 440 can indirectly (e.g., belt drive, gear drive and/or otherwise) or directly couple the fluid end 220 to a rotational output of a windmill, water wheel, or other appropriate source of torque.

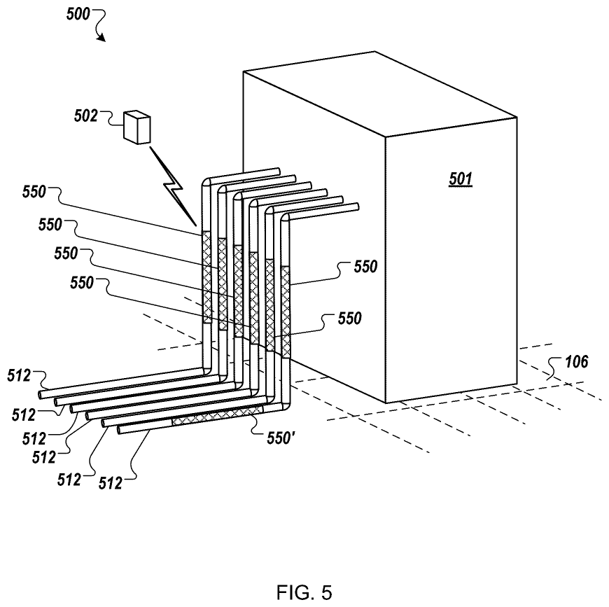

FIG. 5 is a schematic diagram of an example fluid distribution system 500 arranged above the terranean surface 106. FIG. 5 shows how a configuration would appear if configured on the deck of an offshore platform such as a well fluid (e.g., oil and/or gas) production or transport platform, but the concepts are equally applicable to any configuration of fluid distribution system 500, for example, provided at an onshore processing plant, onshore gathering or processing facility or any other location on or offshore. The fluid distribution system 500 includes a manifold 501 configured to receive and distribute fluid flow from, and/or provide fluid flow to, a collection of pipes 512. Each of the pipes 512 shown includes an in-line multiphase fluid system 550, although not all pipes to or from the fluid distribution system 500 need to include a fluid system. FIG. 5 shows a vertical arrangement, but the pipes 512 can include some or all of the segments in a horizontal or other orientation and the in-line multiphase fluid systems 550 can be positioned in these horizontal or other orientation segments. In some embodiments, the in-line multiphase fluid systems 550 can be the example in-line multiphase fluid system 200 of FIGS. 1A, 1B, and 2. In some embodiments, the in-line multiphase fluid systems 550 can be the example in-line multiphase fluid system 400 of FIGS. 4A/4B.

In the context of an offshore platform, and many other manifolded piping arrangements, space is very limited. Thus, the pipes 512 may be closely positioned next to one another, and so closely positioned that there is no space to accommodate a fluid system or other equipment that extends outside the profile of the pipes 512 (e.g., where the impeller or stator housing of the fluid end and/or the motor rotor or stator resides partially or wholly outside the outer diameter of the pipe). Thus, the in-line fluid systems discussed herein can be retrofitted into an existing piping architecture where the pipes 512 were originally positioned not intending to accommodate a fluid system other equipment that extends outside the profile of the pipes 512. In another example, the platform piping architecture can be designed anticipating the use of the in-line multiphase fluid systems 550 to enable the pipes 512 to be more closely spaced than if fluid systems that extend outside the profile of the pipes 512 were to be used. In either instance, the fluid distribution system 500 can be operated to flow fluids for a period of time without the in-line fluid systems installed or with an initial set of in-line fluid systems installed in one or multiple of the pipes 512. Then, as the need arises or otherwise, in-line fluid systems or additional in-line fluid systems can be installed, for example, by installing the in-line fluid systems into one or more of the pipes 512 and/or replacing one or more pipes 512 of the fluid distribution system 500 with pipes having in-line fluid distribution systems installed.

In the illustrated example, the in-line multiphase fluid systems 550 are arranged substantially in parallel and/or independently. In certain instances, another in-line multiphase fluid system 550′ is arranged in fluidic series with one or more of the in-line multiphase fluid systems 550. Various parallel and/or series arrangements of the in-line multiphase fluid systems 550 can be implemented to controllably increase total flow and/or pressure (e.g., through multiple parallel pipes 512) and/or individual flow and/or pressure (e.g., through one or more than one of the multiple parallel pipes 512 so that one or more of the pipes 512 is receiving a different boost from its respective fluid system 550 than one or more of the other pipes 512).

In the illustrated example, the in-line multiphase fluid systems 550 are configured to work as a system that controls the flow and/or pressure of multiphase fluids within a production platform and/or from one or more wells (e.g., the well) to one or more destinations (e.g., customer pipelines, gathering stations, end users, and/or other destinations). A controller 502 is configured to individually control operation of the in-line multiphase fluid systems 550. In some embodiments, the controller 502 can be configured to provide power, command and control signals (e.g., wired or wirelessly) to the in-line multiphase fluid systems 550 to control operation of the in-line multiphase fluid systems 550.

The in-line multiphase fluid systems 550 can be controlled to boost production of wells connected to the platform. In certain instances, each individual well connected to the platform or groups of wells connected to the platform can be connected through a single pipe 512 with an in-line multiphase fluid system 550. In certain instances, one or more of the individual wells connected to the platform may have more than one pipe 512 connected to it so that the in-line multiphase fluid systems 550 can be configured as parallel flow paths from the individual well to the manifold 501.

In some operational examples, the in-line multiphase fluid systems 550 can be controlled to balance multiple wells to a given flow and/or pressure to increase, optimize, and/or maximize fluid production. For example, pipelines can have a rated maximum and/or optimal fluid flow rate, and the need to flow fluid that exceeds those ratings may create a bottleneck. Other pipelines that are flowing fluid at lesser rates can be allowing some fluid carrying capacity to go unused. The in-line multiphase fluid systems 550 can be controlled to reduce excessive flows in some of the pipes 512 (e.g., boosting flow less or not at all) while boosting flows through underutilized ones of the pipes 512.

The in-line multiphase fluid systems 550 are configured to control and/or optimize fluid flow and pressure at specified points within the fluid distribution system 500, as the gas moves from wellhead 110s to gathering stations or end users.

In some operational examples, the in-line multiphase fluid systems 550 can be controlled to dynamically respond to variation in flow line pressure by adjusting individual fluid system speeds to increase, optimize, and/or maximize production at a platform. For example, the controller 502 can be configured to monitor multiphase fluid flow rates and/or pressures in the pipes 512, and slow the in-line multiphase fluid systems 550 in specified ones of the pipes 512 while also speeding the in-line multiphase fluid systems 550 to boost other ones of the pipe 512.

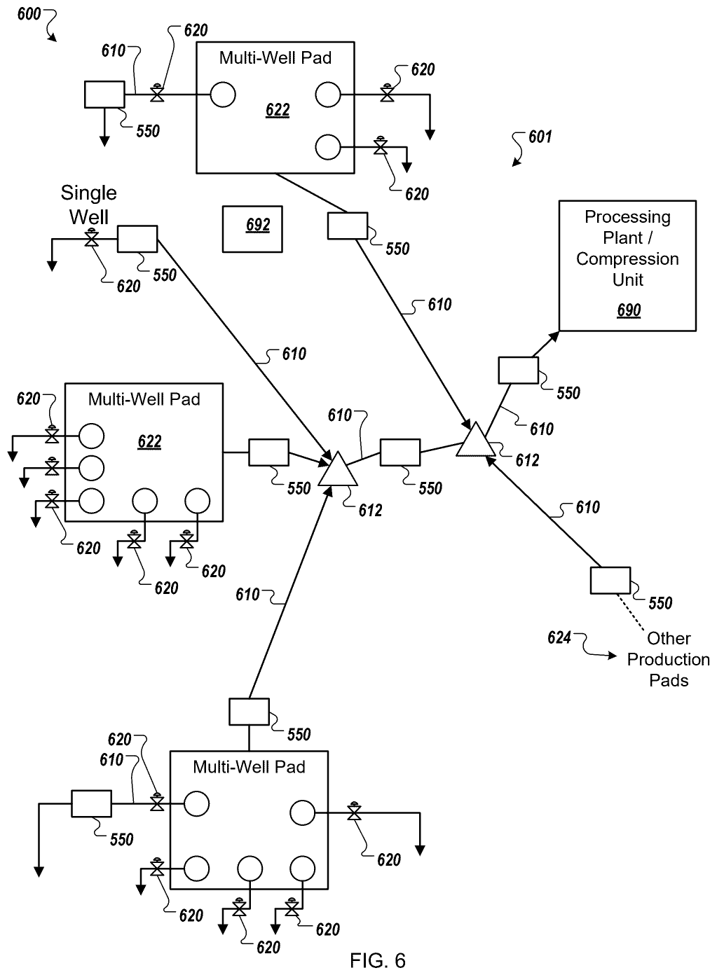

FIG. 6 is a schematic diagram of an example fluid distribution network 600 for a hydrocarbon production field 601 (e.g., gas field, oil field, or other). In general, in-line multiphase fluid systems 550 can be deployed and controlled to increase local and/or fieldwide flow rates and/or pressure at any point in transport of well fluids through the network 600. In the illustrated example, multiple in-line multiphase fluid systems 550 are configured to be controlled by a controller 692 to boost production across the field 601. The network 600 includes a collection of pipelines 610 and manifolds 612 that connect a collection of wells 620, arranged as single wells and multi-well pads 622 and other production pads 624 to a destination 690 (e.g., a processing plant, a compression unit, a custody transfer meter and/or another destination). Of note, the network 600 is shown for the convenience of discussion, only, and in practice, the network 600 can have fewer or more pipelines 610, manifolds 12, wells 620, well-pads 622, production pads 624 and destinations 690 arranged in different manners.

The in-line multiphase fluid systems 550 are configured to act as booster stations for gas lines for onshore or offshore gas processing stations and/or custody transfer meters (CTMs) at sales lines. The in-line multiphase fluid systems 550 can be incorporated at any point in the hydrocarbon stream from wellhead 110 to the sales line. The in-line multiphase fluid systems 550 are configured as an alternative to conventional top-side fluid systems, and can be advantageous due to high flexibility offered by axial fluid systems driven by a variable speed motor, in addition to reducing and/or minimizing gas leakage to the environment, increasing reliability, and reducing power consumption.

The in-line multiphase fluid systems 550 can communicate with each other and/or be controlled by the controller 692 to perform production logging and to control (e.g., increase) local and fieldwide flow rates and/or pressure at any point in transport of well fluids, and/or to tune tool operating parameters and wellhead 110 control to increase recoverable hydrocarbons, cash flow, and reduce deferment. The in-line multiphase fluid systems 550 can be controlled to offset production deferment due to pipeline/equipment/wellbore issues by being rapidly replaceable and/or by being controllable to route fluid flow through excess capacity that is available in other branches of the network 600. In some examples, such command and control capabilities can be referred to as a “smart field”.

In some embodiments, the controller 692 can monitor gas market conditions and control the in-line multiphase fluid systems 550 to change sales line gas and condensate mix as a near real-time response to the market. For example, the controller 692 can control the fluid systems 550 to provide more gas when gas prices are high and less gas when gas prices are low or to control the hydrocarbon mix based to optimize the production of higher priced components.

In some embodiments, the controller 692 can monitor gas market conditions and control the in-line multiphase fluid systems 550 to participate in the gas spot markets by leveraging multiphase fluid system optimization

In some embodiments, one or more of the in-line multiphase fluid systems 550 can be used to provide shorter and/or more flexible inject-back operations. For example, one or more of the in-line multiphase fluid systems 550 can be arranged proximal to one of the wells 620 to re-inject gas back into the well 620 to maintain pressure, potentially enhance recovery rates, and/or be used as a secondary recovery method in oil and gas extraction.

While this disclosure contains many specific implementation details, these should not be construed as limitations on the subject matter or on what may be claimed, but rather as descriptions of features that may be specific to particular implementations. Certain features that are described in this disclosure in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Nevertheless, it will be understood that various modifications, substitutions, and alterations may be made. While operations are depicted in the drawings or claims in a particular order, this should not be understood as requiring that such operations be performed in the particular order shown or in sequential order, or that all illustrated operations be performed (some operations may be considered optional), to achieve desirable results. Accordingly, the previously described example implementations do not define or constrain this disclosure.

What is claimed is:

1. A fluid production system for a well, comprising:
a fluid system configured to reside within a conduit, the conduit residing outside the well, the fluid system comprising:
a fluid end inlet;
a fluid end outlet; and
an impeller arranged between the fluid end inlet and the fluid end outlet and supported to rotate on a first rotational axis;
a first seal carried by the fluid production system downstream from the fluid end inlet and configured to seal a space between the fluid end and an inner wall of the conduit;
a motor comprising a rotor supported to rotate on a second rotational axis, residing on an opposite side of the first seal from the fluid end, and configured to reside external to the conduit;
a magnetic coupling configured to couple the rotor to the impeller to drive the fluid end via the motor; and
a second seal carried by the fluid production system upstream from the fluid end inlet and configured to seal to the inner wall of the conduit proximate the magnetic coupling.

2. The fluid production system of claim 1, comprising the conduit and wherein the conduit comprises:
a first tubular portion around the fluid end outlet defining a first flow axis substantially aligned with the first rotational axis; and
a second tubular portion defining a second flow axis different from the first flow axis, wherein:
the first seal is arranged within the first tubular portion; and
the second seal is arranged between the fluid end inlet and the motor and along the first rotational axis.

3. The fluid production system of claim 1, wherein:
the magnetic coupling comprises:
a first coupling part that comprises a first magnet;
a second coupling part that comprises a second magnet;
the magnetic coupling further comprises a non-magnetic fluid barrier arranged at least partly between the first coupling part and the second coupling part;
the first magnet and the second magnet produce a magnetic field that extends between the first magnet and the second magnet across the non-magnetic fluid barrier; and
the second seal is between the first coupling part and the second coupling part.

4. The fluid production system of claim 3, wherein the rotor is directly coupled to the first coupling part and the impeller is directly coupled to the second coupling part.

5. The fluid production system of claim 1, wherein none of the motor, the fluid end, the first seal, the second seal, or the magnetic coupling comprise a rotating seal.

6. The fluid production system of claim 1, wherein the second rotational axis coincides with the first rotational axis.

7. The fluid production system of claim 1, wherein the fluid end is a multiphase fluid end configured to drive axial flow of multiphase fluid through the conduit in the direction of the first rotational axis.

8. The fluid production system of claim 1, further comprising:
a first magnetic radial bearing configured to support the impeller to the conduit; and
a second radial magnetic bearing configured to support the rotor to a stator of the motor.

9. The fluid production system of claim 1, wherein the motor is configured to rotate the impeller at 10,000 revolutions per minute or more.

10. The fluid production system of claim 1, further comprising a hermetically sealed housing, wherein the motor is arranged within the hermetically sealed housing.

11. The fluid production system of claim 10, wherein the hermetically sealed housing is at least partly filled with an incompressible fluid or encapsulate.

12. The fluid production system of claim 1, wherein the conduit is arranged with a tubular as a wye or a tee, and the fluid system resides in one leg of the wye or tee and the motor resides in another leg of the wye or tee.

13. A method of flowing fluid in a pipeline, the method comprising:
arranging a fluid system within a conduit residing outside of a well and connected in the pipeline, the fluid system comprising:
a fluid end inlet;
a fluid end outlet; and
an impeller arranged between the fluid end inlet and the fluid end outlet and supported to rotate on a first rotational axis;
a first seal carried by the fluid system downstream from the fluid end inlet and configured to seal a space between the fluid end and an inner wall of the conduit;
a motor comprising a rotor supported to rotate on a second rotational axis and configured to reside external to the conduit;
a magnetic coupling configured to couple to the impeller to the motor to drive the fluid end via the motor; and
a second seal carried by the fluid system upstream from the fluid end inlet and configured to seal to the inner wall of the conduit;
fluidically coupling the conduit in a pipeline arranged outside of the well; and
driving, by the fluid system, fluid flow in the conduit from the fluid end inlet toward the fluid end outlet.

14. The method of claim 13, further comprising removing a second conduit from the pipeline, wherein fluidically coupling the conduit in the pipeline further comprises fluidically coupling the conduit in place of the second conduit in the conduit.

15. The method of claim 13, further comprising rotating the motor rotor and the impeller at 10,000 revolutions per minute or more.

16. The method of claim 13, wherein the pipeline is configured to flow between a wellhead and a gathering station.

17. A fluid production system comprising:
a plurality of pipes of a pipeline, the pipeline fluidically connecting a wellhead to one or more destinations; and
a fluid system, comprising:
a fluid end residing within a pipe of the plurality pipes and configured to connect inline in the pipeline, the fluid end comprising;
a fluid end inlet;
a fluid end outlet; and
an impeller arranged between the fluid end inlet and the fluid end outlet and supported to rotate on a first rotational axis;
a first seal carried by the fluid system downstream from the fluid end inlet and configured to seal a space between the fluid end and an inner wall of the pipe;
a motor comprising a rotor supported to rotate on a second rotational axis and configured to reside external to the pipe;
a magnetic coupling configured to couple the rotor to the impeller to drive the fluid end via the motor; and
a second seal carried by the fluid production system upstream from the fluid end inlet and configured to seal to the inner wall of the pipe.

18. The fluid production system of claim 17, wherein the pipe with the fluid end residing therein comprises:
a first tubular portion around the fluid end outlet defining a first flow axis substantially aligned with the first rotational axis; and
a second tubular portion defining a second flow axis different from the first flow axis, wherein:
the first seal is arranged within the first tubular portion; and
the second seal is arranged between the fluid end inlet and the motor and along the first rotational axis.

19. The fluid production system of claim 18, comprising a third tubular portion, wherein the motor resides in the third tubular portion.

20. The fluid production system of claim 19, where the third tubular portion is open to am ambient environment around the pipe.
